(19) United States
(12) Patent Application Publication
(10) Pub. No.: US 2017/0158136 A1
(43) Pub. Date: Jun. 8, 2017

(54) VEHICLE SIDE MIRROR SYSTEM

(71) Applicant: FORD GLOBAL TECHNOLOGIES, LLC, Dearborn, MI (US)

(72) Inventor: Alejandro Israel Garcia Solache, Mexico City (MX)

(21) Appl. No.: 14/957,351

(22) Filed: Dec. 2, 2015

(51) Int. Cl. B60R 1/07; B60R 1/12

(52) U.S. Cl. CPC B60R 1/07; B60R 1/12; B60R 2001/1223

(57) ABSTRACT

A side mirror system for a vehicle includes at least one proximity sensor. A motor is operatively connected to the at least one proximity sensor and configured to displace a side mirror away from a direction of approach of an object. The motor may be configured to displace the side mirror along a 180° radius. A controller is included for causing the motor to said displace the side mirror. A first proximity sensor may provide a signal to the controller indicative of an approaching object that is within a predetermined threshold distance from the vehicle. Next proximity sensors provide signals to the controller to cause the motor to displace the side mirror from an original side mirror orientation to a folded orientation. A last proximity sensor provides a signal to the controller to cause the motor to return the side mirror to the original orientation.

### TECHNICAL FIELD

This disclosure relates generally to powered side mirrors for motor vehicles, and more particularly to a vehicle side mirror system configured for detecting obstacles approaching the vehicle in either a vehicle-fore or vehicle-aft direction which could potentially contact the side mirror. The side mirror displaces in a vehicle-fore or vehicle-aft direction according to the direction of approach of the obstacle, thus avoiding damage to the mirror.

### BACKGROUND

Often motorists must contend with areas of extremely dense traffic where adjacent vehicles are not well spaced-apart. For example, the major thoroughfares of certain heavily populated cities often have very dense traffic that is not well aligned in defined lanes. Likewise, often vehicles pass very close to one another in jurisdictions which permit lane-splitting, i.e. bicycles and motorcycles passing between slow or stopped cars positioned in adjoining lanes. Other exemplary situations include confined areas such as parking lots, parking garages, etc.

In such situations where vehicles must approach and/or pass other objects at very close distances, often peripheral items such as side mirrors which extend outwardly from a vehicle body may contact the objects. This risks damage to the peripheral items, increasing consumer costs associated with repairs, insurance, etc. Even if the side mirror is not broken it will likely be displaced from its user-set orientation, requiring the vehicle operator to reposition it. It may not be possible for the operator to exit the roadway immediately, and so this risks accidents while the operator attempts to reposition the mirror while still operating the vehicle.

To solve these and other problems, the present disclosure relates to a vehicle side mirror system including a proximity sensor array. Advantageously, the described system causes the vehicle side mirrors to fold towards the vehicle body in a direction opposite to that of an approaching object, for example a passing vehicle or a stationary object being passed.

### SUMMARY

In accordance with the purposes and benefits described herein, in one aspect a side mirror system for a vehicle is described, comprising at least one proximity sensor. A motor is operatively connected to the at least one proximity sensor and configured to displace a side mirror away from a direction of approach of an object. The motor is configured to displace the side mirror along a 180° radius. The system further includes a controller for causing the motor to said displace the side mirror on receipt of inputs from the at least one proximity sensor.

In embodiments, the system includes a first proximity sensor disposed on at least one vehicle side for providing a signal to the controller indicative that the approaching object is at or within a predetermined distance threshold from the vehicle. A next proximity sensor provides a signal to the controller to cause the motor to begin displacing the side mirror from an original side mirror orientation to a folded orientation. Another next proximity sensor provides a signal to the controller to cause the motor to complete said displacement of the side mirror to the folded configuration. A last proximity sensor provides a signal to the controller to cause the motor to return the side mirror to the original orientation.

In another aspect, a side mirror system for a vehicle is described including a side mirror, a controller, a plurality of proximity sensors, and a motor operatively connected to the controller to displace the side mirror away from a direction of approach of an object. The motor may be configured to displace the side mirror along a 180° radius.

In embodiments, the plurality of proximity sensors are arranged in a linear sequence on the vehicle side in a vehicle-fore and vehicle-aft configuration relative to a position of the side mirror. The plurality of sensors may include a first-in-sequence proximity sensor for providing a signal to the controller indicative that the approaching object is at or within a predetermined distance threshold from the vehicle. A next-in-sequence proximity sensor may be included for providing a signal to the controller to cause the motor to begin displacing the side mirror from an original side mirror orientation to a folded orientation. Another next-in-sequence proximity sensor may be included for providing a signal to the controller to cause the motor to complete said displacement of the side mirror to the folded orientation. A last-in-sequence proximity sensor may be included for providing a signal to the controller to cause the motor to return the side mirror to the original orientation. In embodiments, each of the plurality of proximity sensors is an ultrasonic sensor. In embodiments, the plurality of proximity sensors includes an array of six proximity sensors.

In the following description, there are shown and described embodiments of the disclosed vehicle side mirror system. As it should be realized, the system is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed vehicle side mirror system, and together with the description serve to explain certain principles thereof. In the drawing:

FIG. 1 is a side view of a vehicle including a side mirror system according to the present disclosure;

FIG. 2 schematically depicts a controller system for the side mirror system of FIG. 1;

FIG. 3 shows operation of the side mirror system in the event of approaching objects;

FIG. 4 depicts continued operation of the side mirror system, with a side mirror beginning to translate to a folded orientation;

FIG. 5 depicts continued operation of the side mirror system, with the side mirror in a fully folded orientation; and

FIG. 6 depicts operation of the side mirror system after the object has passed, with the side mirror translating back to the original orientation.

Reference will now be made in detail to embodiments of the disclosed vehicle side mirror system, examples of which are illustrated in the accompanying drawing figures.

### DETAILED DESCRIPTION

Preliminarily, as summarized above the present disclosure is primarily directed to a vehicle side mirror system including a proximity sensor and a motor for causing a side mirror to fold towards a side of the vehicle in a same direction as that of an oncoming object, for example a passing vehicle or an object which the side mirror system-equipped vehicle is passing. A variety of suitable proximity sensors and motors for controlling power side mirrors are well-known to the skilled artisan, and use of any such sensors and/or motors is contemplated. For example, proximity sensors are known based on a variety of technologies, including without intending any limitation cameras, lasers (LIDAR), radar, sonar, ultrasound, and others as are known in the art. Such systems are known, and the specific construction of such need not be described in detail herein. Therefore, this aspect of the disclosure does not require detailed description, and the descriptions that follow will not be taken as limiting in regard to the above-described features.

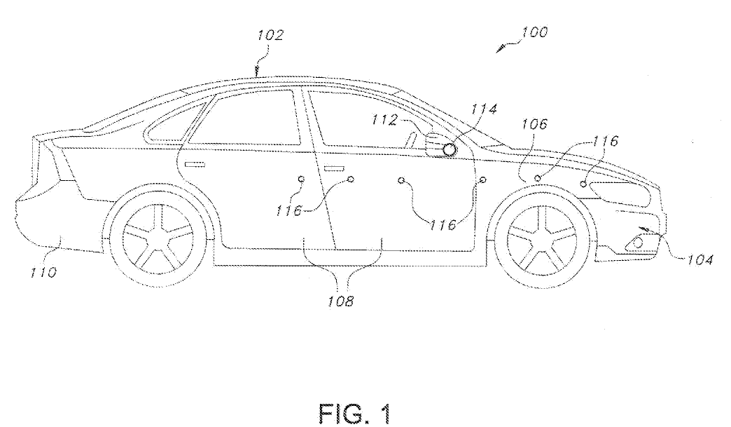

With reference to FIG. 1, there is depicted a vehicle 100 including a side mirror system according to the present disclosure. The vehicle 100 includes a body 102 having opposed sides 104 typically comprising a front fender panel 106, at least one door 108, and a rear fender panel 110. In turn, the vehicle includes at least one side mirror 112 (typically a pair of side mirrors 112 disposed on opposite sides 104 of the vehicle body).

The side mirror 112 is operatively connected to a motor 114 configured for displacing the side mirror 112 from an original orientation as shown in FIG. 1. The motor 114 is configured to displace the side mirror 112 along a 180° path of travel, to allow folding the mirror in either direction along the 180° path of travel and towards the vehicle side 104 as will be described below. A number of suitable motors 114, including servo motors and others are known in the art and contemplated for use hereon.

In turn, the vehicle 100 includes a plurality of proximity sensors 116 arranged on the vehicle side 104. In the depicted embodiment, the proximity sensors 116 are arranged on the vehicle side 104 as a substantially linear array, for reasons which will be discussed in detail below. In the depicted embodiment, the proximity sensors 116 are disposed whereby a portion of the sensors are positioned vehicle-fore of the side mirror 112 and a portion of the sensors are positioned vehicle-aft of the side mirror. In the depicted embodiment, three sensors 116 of a six-sensor array are positioned vehicle-fore of the side mirror 112 and the remaining three sensors are positioned vehicle-aft of the side mirror. However, as will be appreciated the specific numbers and positioning of the proximity sensors 116 may vary according to vehicle body 102 configuration and dimensions, sensor 116 sensitivity, motor 114 speed and power, etc. In one embodiment, use of ultrasonic proximity sensors 116 is contemplated.

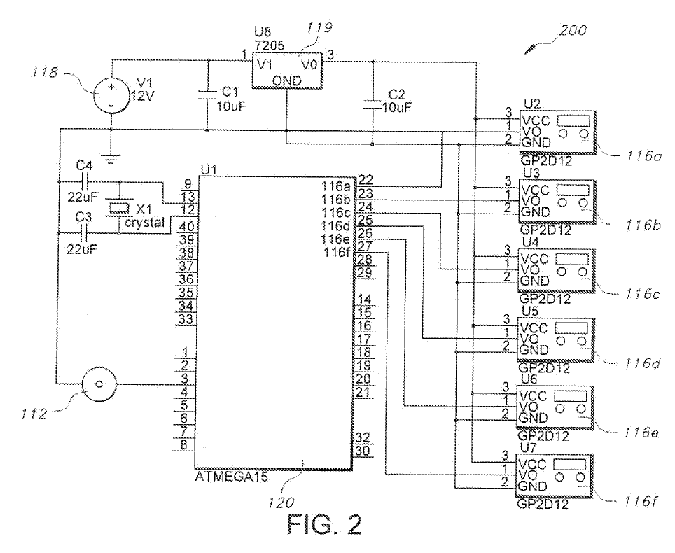

With reference to FIG. 2, a circuit diagram for a microcontroller system 200 for the described side mirror system is shown. As shown, the system includes a power source 118 for providing power to the system. This may be a vehicle battery (not shown) or a separate dedicated power source. A voltage reducer 119 may be included to control a voltage supplied to power the system. A controller 120 is provided for controlling operation of the system. The controller 120 may be one or more microcontrollers of known design including a processor core, memory, and one or more programmable input/output peripherals, or any other suitable controller. In the depicted embodiment, six proximity sensors 116 (labeled 116a, 116b, 116c, 116d, 116e, and 1160 are included in the circuit. The sensors 116 as depicted are ultrasonic sensors, configured to emit an ultrasonic signal to contact an adjacent object O (not shown). The ultrasonic signal reflects back from the object O to contact the sensor, which sends an input to the controller 120. The controller 120 interprets the sensor 116 input as an x variable for the object O, i.e. a calculated distance of the object O from the sensor 116 in the x direction.

The controller 120 is further configured to match that calculated distance to a predetermined distance stored in the controller 120 memory, for example, a lookup table. Only objects O determined to be within a threshold distance likely to result in contact with the side mirror 112 will trigger the system. The controller 120 is also configured to determine which proximity sensor 116 in the array first detects the oncoming object O, and to send a signal to the motor 114 to cause it to fold the mirror 112 in a direction opposite to that of the oncoming object O to avoid contact with the mirror. By this expedient, the more complicated calculating task of determining from sensor input a direction of travel of the object O relative to the vehicle 100 is avoided.

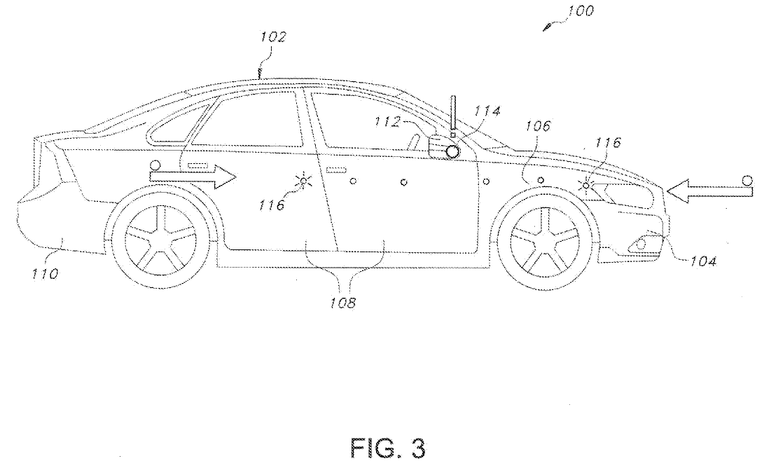

In more detail, with reference to FIG. 3 an object O is depicted approaching the side mirror 112 in a direction of travel (see arrows). As will be appreciated, this object O could be a vehicle approaching the vehicle 100 from an opposite direction, could be a vehicle approaching the vehicle 100 from behind, or alternatively could be a stationary object O which the vehicle 100 is approaching. The object O comes into the detection range of a first-in-sequence proximity sensor 116 relative to the direction in which the object O approaches the sensor. That is, the first-in-sequence proximity sensor 116 will be the first proximity sensor in the array of proximity sensors 116 that will detect the oncoming object O due to the objects direction of travel relative to the vehicle 100. As will be appreciated, the specific proximity sensor 116 of the array that first detects the oncoming object O will vary in accordance with the direction in which the object is approaching the vehicle 100. That first proximity sensor 116 sends an input alerting the controller 120 of the presence of the oncoming object O. The controller determines from the sensor input data whether the object O is within a predetermined distance from the vehicle 100 such that there is risk that the object O will strike the side mirror 112, and uses the identity of the specific proximity sensor 116 that first detects the object to determine which direction to cause the motor 114 to fold the mirror 112.

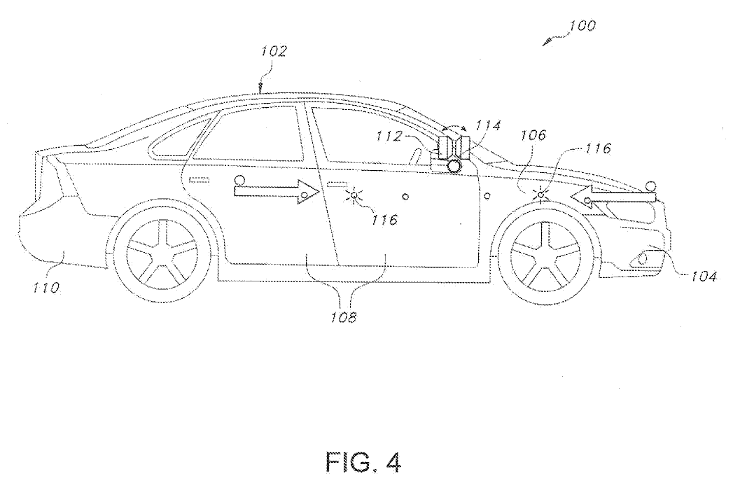

If the object O continues to approach the side mirror 112, it comes into the detection range of a next-in-sequence proximity sensor 116 (see FIG. 4). This next-in-sequence proximity sensor 116 sends an input indicative that the object is still at or within the threshold distance, causing the controller 120 to in turn send a signal causing the motor 114 to begin to displace the side mirror 112 in the required same direction as that in which the object O is approaching the mirror, folding it in towards the vehicle side 104.

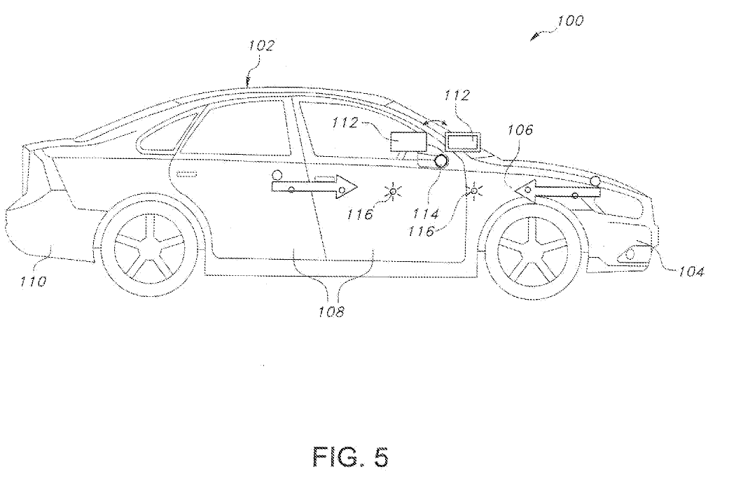

If the object O continues to approach the side mirror 112, it comes into the detection range of another next-in-sequence proximity sensor 116 (see FIG. 5). This another next-in-sequence proximity sensor 116 sends an input indicative that the object is still at or within the threshold distance, causing the controller 120 to in turn send a signal causing the motor 114 to complete the process of displacing the side mirror 112 in the required same direction as that in which the object O is approaching the mirror, folding it along a 90° radius towards the vehicle side 104.

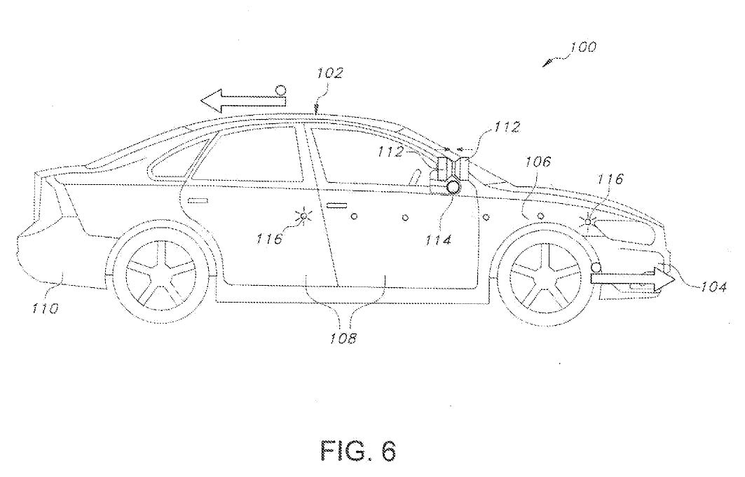

As the object O continues past the vehicle side 104, passing the folded mirror 112, it comes into the detection range of a last-in-sequence proximity sensor 116 (see FIG. 6). This last-in-sequence proximity sensor 116 sends input to the controller 120 which in turn sends a signal causing the motor 114 to reverse the process, returning the mirror 112 to the original orientation shown in FIG. 1.

Of course, if at any point the object O is determined not to be within the threshold distance as determined by one or more of the proximity sensors 116, the controller interprets this sensor input accordingly and sends a signal to the motor 114 to reverse the process and return the mirror 112 to the original orientation shown in FIG. 1. For example, if the object O is determined to be within the threshold distance by the first proximity sensor 116 but not the next-in-sequence proximity sensor 116, the controller will not issue the command to begin folding the mirror 112 in as shown in FIG. 4. Likewise, if the if the object O is determined to be within the threshold distance by the next-in-sequence proximity sensor 116 but not the another next-in-sequence proximity sensor 116, the controller signals the motor 114 to stop the process of folding the mirror 112 in as shown in FIG. 5 and to return the mirror to the original configuration shown in FIG. 1.

Obvious modifications and variations are possible in light of the above teachings. For example, in lieu of the linear six-sensor array described above, more or fewer sensors 116 could be provided, and the controller 120 could be configured to calculate a distance from the vehicle side 104 of an object O using input from those more or fewer sensors. This process could even be performed with a single appropriately configured sensor 116 and a suitable controller 120. The controller 120 may individually actuate side mirrors 112 disposed on opposed sides 104 of the vehicle 100 in accordance with which side 104 the object O is approaching, or may actuate both mirrors 112 simultaneously regardless of the position of object O. All such modifications and variations are within the scope of the appended claims when interpreted in accordance with the breadth to which they are fairly, legally and equitably entitled.

What is claimed:

1. A side mirror system for a vehicle, comprising:
at least one proximity sensor; and
a motor operatively connected to the at least one proximity sensor and configured to displace a side mirror away from a direction of approach of an object.

2. The system of claim 1, wherein the motor is configured to displace the side mirror along a 180° radius.

3. The system of claim 1, further including a controller for causing the motor to said displace the side mirror.

4. The system of claim 3, including a first proximity sensor disposed on at least one vehicle side for providing a signal to the controller indicative that the approaching object is at or within a predetermined distance threshold from the vehicle.

5. The system of claim 3, including a next proximity sensor for providing a signal to the controller to cause the motor to begin displacing the side mirror from an original side mirror orientation to a folded orientation.

6. The system of claim 3, including at least one another next proximity sensor for providing a signal to the controller to cause the motor to complete said displacement of the side mirror to the folded configuration.

7. The system of claim 3, including a last proximity sensor for providing a signal to the controller to cause the motor to return the side mirror to the original orientation.

8. The system of claim 1, including said at least one proximity sensor disposed on opposed vehicle sides.

9. A motor vehicle including the system of claim 1.

10. A side mirror system for a vehicle, comprising:
a side mirror;
a controller;
a plurality of proximity sensors; and
a motor operatively connected to the controller to displace the side mirror away from a direction of approach of an object.

11. The system of claim 10, wherein the motor is configured to displace the side mirror along a 180° radius.

12. The system of claim 10, wherein the plurality of proximity sensors are arranged on a vehicle side in a linear sequence in a vehicle-fore and vehicle-aft configuration relative to a position of the side mirror.

13. The system of claim 10, including a first-in-sequence proximity sensor on a vehicle side for providing a signal to the controller indicative that the approaching object is at or within a predetermined distance threshold from the vehicle.

14. The system of claim 10, including a next-in-sequence proximity sensor for providing a signal to the controller to cause the motor to begin displacing the side mirror from an original side mirror orientation to a folded orientation.

15. The system of claim 10, including at least one another next-in-sequence proximity sensor for providing a signal to the controller to cause the motor to complete said displacement of the side mirror to the folded orientation.

16. The system of claim 10, including a last-in-sequence proximity sensor for providing a signal to the controller to cause the motor to return the side mirror to the original orientation.

17. The system of claim 10, including said plurality of proximity sensors arranged on opposed vehicle sides.

18. The system of claim 10, wherein each of the plurality of proximity sensors is an ultrasonic sensor.

19. The system of claim 10, including six proximity sensors.

20. A motor vehicle including the system of claim 10.
